(19) United States
(12) Patent Application Publication
(10) Pub. No.: US 2024/0015440 A1
(43) Pub. Date: Jan. 11, 2024

(54) Volume Control Device for An Audio Delivery System

(71) Applicant: Multimedia LED, Inc., Corona, CA (US)

(72) Inventors: Alexander Donald Birner, Corona, CA (US); Frederick N. Lietzman, Corona, CA (US)

(21) Appl. No.: 17/862,098

(22) Filed: Jul. 11, 2022

(51) Int. Cl. H04R 5/04; H04R 1/40

(52) U.S. Cl. CPC H04R 5/04; H04R 1/406; H04R 2430/01; H04R 2430/20; H04R 3/005

(57) ABSTRACT

An audio delivery system includes a volume control device for controlling a sound system to adjust for the effects of mobile sound sources, such as people entering or leaving a space. The volume control device includes a direction of arrival microphone having a plurality of microphones, and a computer processor and a computer memory. The computer memory stores executable code that enables the system to identify and track the mobile sound sources via the direction of arrival microphone, determine the effect of the sound sources on the space, and transmit control signals, via a communications device, to the sound system, for adjusting a volume of the speaker to adjust for the effect of the mobile sound sources.

### BACKGROUND OF THE INVENTION

### Field of the Invention

This invention relates generally to audio systems, and more particularly to an audio delivery system that incorporates a volume control device that includes a direction of arrival microphones and artificial intelligence to control a sound system to automatically and dynamically control the volume of sound in a space in response to changes in the sound environment of the space.

### Description of Related Art

Various electronic systems have been utilized for improving sound quality in a sound system. For example, noise cancellation systems have been used to cancel out ambient noise. However, mobile sound sources, in particular people, are much more difficult to counter. Some venues may have very inconsistent sound quality based upon the number of people at the venue, and how loud those people might be.

There is a long-felt need in this field for a system to adequately compensate for mobile sound sources, and in particular groups of crowds of humans (e.g., attendees at an event) entering or leaving an event. The present invention fulfills these needs and provides further advantages as described in the following summary.

### SUMMARY OF THE INVENTION

The present invention teaches certain benefits in construction and use which give rise to the objectives described below.

The present invention provides an audio delivery system that includes a volume control device for controlling a sound system to adjust for the effects of mobile sound sources, such as people entering or leaving a space. The volume control device includes a direction of arrival microphone having a plurality of microphones, and a computer processor and a computer memory. The computer memory stores executable code that enables the system to identify and track the mobile sound sources via the direction of arrival microphone, determine the effect of the sound sources on the space, and transmit control signals, via a communications device, to the sound system, for adjusting a volume of the speaker to adjust for the effect of the mobile sound sources.

A primary objective of the present invention is to provide an audio delivery system 10 having advantages not taught by the prior art.

Another objective is to provide an audio delivery system that includes a volume control device that is able to track mobile sound sources such as people, and adjust the volume of speakers to provide the correct for the crowds, so that people in a space are best able to enjoy the sound, without it becoming too loud or too quiet.

A further objective is to provide a volume control device that incorporates artificial intelligence to quickly adapt to a given space under different conditions.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention.

FIG. 1 is a perspective view of a volume control device according to one embodiment of the present invention.

FIG. 2 is block diagram of the audio delivery system illustrating the volume control device operably connected with a sound system having a plurality of speakers.

FIG. 3 is a plan view of a space in which one embodiment of the volume control device has been installed.

FIG. 4 is a plan view of a larger space in which another embodiment of the volume control device has been installed, wherein the larger space has been subdivided into four zones, each of which is independently monitored and controlled.

### DETAILED DESCRIPTION OF THE INVENTION

The above-described drawing figures illustrate the invention, an audio delivery system 10 for controlling sound in a space 12. In one embodiment, the audio delivery system 10 includes a volume control device 20 that operably controls a sound system 40 having at least one speaker 42 located in the space 12, and transmits control signals to the sound system 40, for adjusting the volume of the speaker(s) 42 to adjust for the effect of the mobile sound sources 14 (e.g., human sound sources) in the space 12.

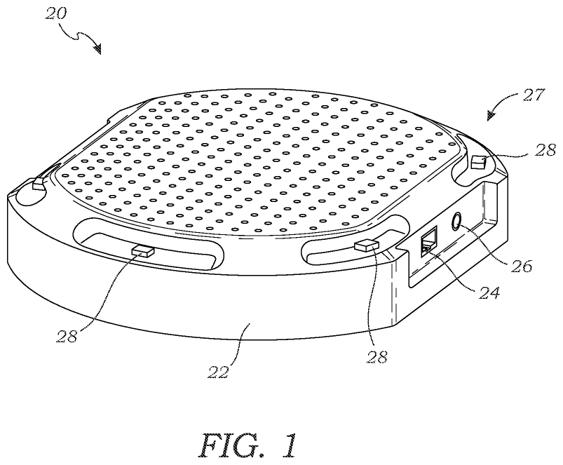

FIG. 1 is a perspective view of the volume control device 20 according to one embodiment of the present invention. As shown in FIG. 1, the volume control device 20 may be embodied in a single unit that includes a housing 22 that contains and protects the various electronics described below. In this embodiment, the housing 22 is generally disk shaped and is roughly 4.5 inches in diameter; however, the specific size and shape may vary according the needs of the user. The volume control device 20 might embody a plurality of such units, and in other embodiments the volume control device 20 might be incorporated into different structures, such as a unit that hangs from a ceiling, is mounted on a wall, or it may be incorporated into other electronics audio/visual devices.

As shown in FIG. 1, the housing 22 may further include ports such as a communications port 24 (e.g., ethernet port, and/or any other equivalent port known in the art, or a wireless transceiver, etc.), a power receiving port 26, and any other such ports that may be desired for integration into the audio delivery system 10. The specific embodiment of these components may vary without deviating from the general principals of the present invention, and such alternative embodiments should be considered within the scope of the present invention.

As shown in FIG. 1, the volume control device 20 includes a direction of arrival microphone 27 having a plurality of microphones 28 operably spaced predetermined distances from each other on a substrate, such as the housing 22, or a printed circuit board stored on or within the housing 22, or any other structure or structures that may be desired. In this embodiment, the plurality of microphones 28 are in a circular arrangement; however, in another embodiment, they might be arranged in a spherical arrangement, or they may be spaced in other patterns, so long as the arrangement and spacing are known and incorporated into the software for determining the direction of sound (e.g., via triangulation or other known method).

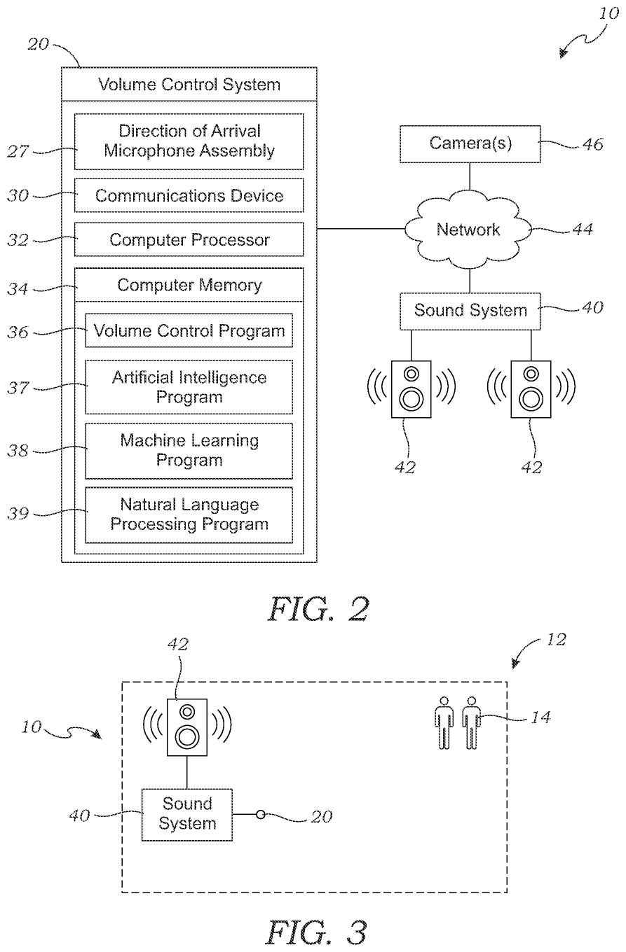

FIG. 2 is block diagram of the audio delivery system 10 illustrating the volume control device 20 operably connected with a sound system 40 having a plurality of the speakers 42. As shown in FIGS. 1-2, the volume control device 20 includes the direction of arrival microphone 27 having the plurality of microphones 28. The direction of arrival microphone 27 may be mounted on a printed circuit board (PCB) (not shown) mounted on or within the housing (such as the housing shown in FIG. 1), or it may be otherwise mounted using any method known in the art. In the embodiment of FIGS. 1-2, the plurality of microphones 28 of the direction of arrival microphone 27 are disposed in a circle (as shown in FIG. 1). In an alternative embodiment the plurality of microphones are disposed in a sphere, or any other shape, so long as the disposition of the microphones is predetermined so that the direction of arrival microphone 27 is able to function as described herein for tracking sound sources. For purposes of this application, the term “circle” is broadly defined to include any form of generally circular or oval shape.

As shown in FIG. 2, the volume control device 20 further includes a communications device 30 for operably communicating with the sound system 40 via a communication network 44 for transmitting control signals for controlling the sound system 40 and for controlling the volume of the speaker 42. The communications device 30 may be any form of port, modem, transceiver, and/or any other mechanisms known in the art as suitable for network communications.

As shown in FIG. 2, the volume control device 20 further includes a computer processor 32 and a computer memory 34, as defined in more detail below. The computer memory 34 stores executable code that, when executed, enables the computer processor 32 to perform a process described in more detail below. As shown in FIG. 2, in this embodiment the computer memory 34 includes a volume control program 36, an artificial intelligence program 37, machine learning program 38, and natural language processing program 39, each of which are described in greater detail below.

The volume control program 36 functions to track mobile sound sources 14, as discussed in more detail below, for adjusting the volume of the speakers 42 to adjust for the impact of the mobile sound sources 14, in conjunction with the artificial intelligence program 37 and the machine learning program 38. The volume control program 36, the artificial intelligence program 37, and the machine learning program 38 together track changes in a sound environment of the space 12, making adjustments in response to the mobile sound sources 14, and then monitoring the end results, to determine whether the response was effective. Over time, the system is able to learn, so that the proper responses may be determined for each individual space 12.

In some embodiments, the executable code stored in the computer memory includes a natural language processing program 39 that functions to determine a verbal command received via the direction of arrival microphone 27, and wherein the volume control device 20 performs predetermined actions upon receipt of the verbal command. The natural language processing program 39 may function to monitor the space 12 and the mobile sound sources 14, via the direction of arrival microphone 27, for any predetermined commands. “Wake words” may be predetermined to trigger a receiving state where the system is able to receive commands for the adjustment of the sound environment, or other commands, from “on” and “off”, to higher volume or lower volume, etc. Similarly, “hot words” and “keywords” may be used to automatically trigger predetermined processes, as desired by persons responsible for the sound environment of the space 12, and/or any other authorized personnel.

FIG. 3 is a plan view of a space 12 in which one embodiment of the volume control device 20 has been installed. As shown in FIG. 3, the space 12 has installed therein the audio delivery system 10 described above. In this embodiment, this is a small area (e.g., a bar, room, or other small area with simple requirements. In this embodiment, a single one of the volume control device 20 is installed and operably connected with the sound system 40 having a single speaker 42.

In the space 12 shown in FIG. 3, one or more mobile sound sources 14, in this case two people, are illustrated entering the space 12. Using the systems shown in FIGS. 1-2, the software and associated programs described above function to identify and track the mobile sound sources 14 in the space 12, via the direction of arrival microphone 27 (shown in FIG. 2). This would typically focus on humans attending an event in the space 12; however, any mobile sound sources may be included or excluded, as required. Ambient noise may also be determined, and adjustments may be made, but mobile sound sources 14 are the major concern of the present invention, as large numbers of persons may be entering and leaving the space 12.

With reference to FIGS. 1-3, in operation, the effects of the mobile sound sources 14 on the space 12 is determined. First, all of the mobile sound sources 14 are tracked in the space 12 via the direction of arrival microphone 27. The number of mobile sound sources 14 is determined, and measurement is taken of how loud each of the mobile sound sources 14 is. An amplitude of sound coming from the mobile sound sources is determined, based upon the measurement of the amplitude of the sound, and the distance of the sound source 14 from the volume control device 20. The effect of the mobile sound sources 14 on the sound environment of the space 12 is determined. Finally, control signals or other forms of instructions are transmitted, via the communications device 30 and through the communications network, to the sound system 40, for automatically and dynamically adjusting a volume of each of the plurality of speakers 42 to adjust for the effect of the mobile sound sources entering and leaving the space 12.

In one embodiment, the executable code stored in the computer memory includes artificial intelligence and machine learning programs 37 and 38 that enable the volume control device 20 to more accurately react to the sound sources 14 so that the sound environment of the space 12 remains consistent. Through repeated changes in the sound environment of the space 12, and repeated changes in speaker 42 volume, the system 10 is able to learn the various acoustical effects of the mobile sound sources 14 on the space 12, and how to compensate for them.

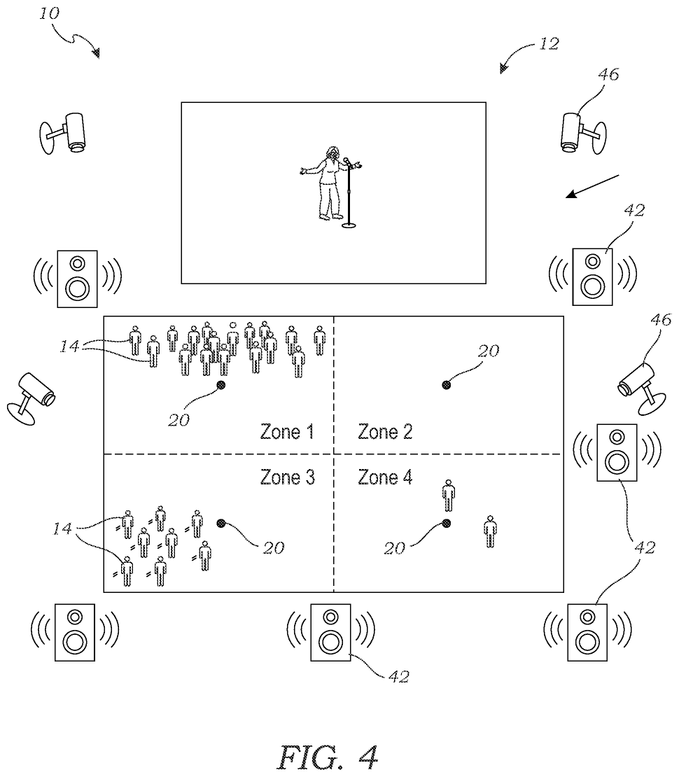

FIG. 4 is a plan view of a larger space 12 in which another embodiment of the system 10 has been installed, wherein the larger space 12 has been subdivided into four zones (zones 1, 2, 3, and 4), each of which is independently monitored and controlled by one of the volume control devices 20. As shown in FIG. 4, different crowds of people in the different zones form the mobile sound sources 14, all having different effects on the space 12. For example, the volume control device 20 in zone 1 might be tracking a large group of people near the stage of a performance, all of whom are being fairly quiet and listening to the performance, and this large crowd of quit people will have a certain effect on the sound qualities of zone 1, which the system 10 could determine and counter. Meanwhile, zone 2 would remain unaffected due to the lack of people in this area.

As further shown in FIG. 4, zone 3 might be impacted by a large number of people (i.e., the mobile sound sources 14), entering, talking and being very loud, in which case the system 10 would adjust, with the volume control device 20 in this zone sending signals to the sound system to increase the volume of nearby speakers 42. Zone 4 might be consistent in sound, with only a couple of people who are standing quietly alone. In this manner, louder sound may be provided to the crowded zone 1, without increasing the sound to a higher level in zone 2 (which might otherwise make zone 2 uncomfortable). The system 10 is also able to dynamically adjust to the influx of loud people into zone 3, without causing discomfort to those standing quietly in zone 4.

While this illustrates one potential embodiment of the invention, any number of arrangements and configurations may be used, with differing numbers of volume control devices 20 and speakers 42, disposed as best suited for any given space.

Also shown in FIG. 4, the system 10 may further include cameras 46 operably positioned on or around the space 12 for monitoring the mobile sound sources 14. The cameras 46 may be used in conjunction with the direction of arrival microphone 27 to most accurately determine the number of mobile sound sources 14, especially for catching very quiet sound sources which might otherwise escape the notice of the direction of arrival microphone 27, but which might affect the sound quality of the space 12, and who might become much louder at another time.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean +/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A volume control device for controlling a sound system having a speaker located in a space, to adjust for the effects of mobile sound sources, the volume control device comprising:
a direction of arrival microphone having a plurality of microphones;
a communications device for operably communicating with the sound system via the communication network;
a computer processor and a computer memory, the computer memory storing executable code that, when executed, performs a process comprising the steps of:
identifying and tracking mobile sound sources in the space via the direction of arrival microphone;
determining the effect of the sound sources on the space; and
transmitting control signals, via the communications device, to the sound system, for adjusting a volume of the speaker to adjust for the effect of the mobile sound sources.

2. The volume control device of claim 1, wherein the plurality of microphones of the direction of arrival microphone are disposed in a circle.

3. The volume control device of claim 1, wherein the executable code stored in the computer memory includes a natural language processing program that functions to determine a verbal command received via the direction of arrival microphone, and wherein the volume control device performs predetermined actions upon receipt of the verbal command.

4. The volume control device of claim 1, wherein the executable code stored in the computer memory includes artificial intelligence and machine learning program that enables the volume control device to more accurately react to the mobile sound sources so that the sound environment of the space remains consistent.

5. The volume control device of claim 1, wherein the step of determining the effect of the mobile sound sources on the space is performed in conjunction with an artificial

6. The volume control device of claim 1, wherein the executable code functions to perform the following steps:
determining the number of the mobile sound sources;
determining a location of each of the mobile sound sources;
determining an amplitude of sound coming from the mobile sound sources;
determining the effect of the mobile sound sources on the sound environment of the space; and
transmitting instructions, via the communications device, to the sound system, for automatically and dynamically adjusting a volume of each of the plurality of speakers to adjust for the effect of the mobile sound sources.

7. A volume control device for controlling a sound system having a speaker located in a space via a communication network, to adjust for the effects of mobile sound sources, the volume control device comprising:
a direction of arrival microphone having a plurality of microphones operably spaced predetermined distances from each other on;
a communications device for operably communicating with the sound system via the communication network for transmitting control signals for controlling the sound system for controlling the volume of the speaker;
a computer processor and a computer memory, the computer memory storing executable code that, when executed, performs a process comprising the steps of:
identifying and tracking mobile sound sources in the space via the direction of arrival microphone;
determining the effect of the sound sources on the space; and
transmitting control signals, via the communications device and through the communications network, to the sound system, for adjusting a volume of the speaker to adjust for the effect of the mobile sound sources.

8. The volume control device of claim 7 wherein the plurality of microphones of the direction of arrival microphone are disposed in a circle.

9. The volume control device of claim 7, wherein the executable code stored in the computer memory includes a natural language processing program that functions to determine a verbal command received via the direction of arrival microphone, and wherein the volume control device performs predetermined actions upon receipt of the verbal command.

10. The volume control device of claim 7, wherein the executable code stored in the computer memory includes artificial intelligence and machine learning program that enables the volume control device to more accurately react to the mobile sound sources so that the sound environment of the space remains consistent.

11. The volume control device of claim 7, wherein the step of determining the effect of the mobile sound sources on the space is performed in conjunction with an artificial

12. The volume control device a claim 7, wherein the executable code functions to perform the following steps:
determining the number of the mobile sound sources;
determining a location of each of the mobile sound sources;
determining an amplitude of sound coming from the mobile sound sources;
determining the effect of the mobile sound sources on the sound environment of the space; and
transmitting instructions, via the communications device and through the communications network, to the sound system, for automatically and dynamically adjusting a volume of each of the plurality of speakers to adjust for the effect of the mobile sound sources entering and leaving the space.
